(19) United States
(12) Patent Application Publication
(10) Pub. No.: US 2017/0262439 A1
(43) Pub. Date: Sep. 14, 2017

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Yoshihiro UEDA, Yokohama-shi (JP)

(73) Assignee: FUJI XEROX CO., LTD., Tokyo (JP)

(21) Appl. No.: 15/236,491

(22) Filed: Aug. 15, 2016

(30) Foreign Application Priority Data
Mar. 9, 2016 (JP) 2016-045326

(51) Int. Cl. G06F 17/30

(52) U.S. Cl. CPC G06F 17/30011; G06F 17/30091

(57) ABSTRACT

An information processing apparatus includes an extraction unit, a determination unit, and a replacement unit. The extraction unit extracts the identical document stored in storage places of a plurality of document storage apparatuses. The determination unit determines a representative storage place which becomes a representative of the storage places of the plurality of document storage apparatuses. The replacement unit replaces documents which exist in storage places other than the representative storage place with links which point to the representative storage place.

### CROSS-REFERENCE TO RELATED APPLICATIONS

This application is based on and claims priority of Japanese Patent Application No. 2016-045326 filed on Mar. 9, 2016. The entirety of the above-mentioned patent applications are hereby incorporated by reference herein and made a part of this specification.

### BACKGROUND

### Technical Field

The present invention relates to an information processing apparatus and a non-transitory computer readable medium.

### SUMMARY

An aspect of the invention provides an information processing apparatus including an extraction unit, a determination unit, and a replacement unit. The extraction unit extracts the identical document stored in storage places of a plurality of document storage apparatuses. The determination unit determines a representative storage place which becomes a representative of the storage places of the plurality of document storage apparatuses. The replacement unit replaces documents which exist in storage places other than the representative storage place with links which point to the representative storage place.

Another aspect of the invention provides a non-transitory computer readable medium storing a program causing a computer to function as an extraction unit, a determination unit, and a replacement unit. The extraction unit extracts the identical document stored in storage places of a plurality of document storage apparatuses. The determination unit determines a representative storage place which becomes a representative of the storage places of the plurality of document storage apparatuses. The replacement unit replaces documents which exist in storage places other than the representative storage place with links which point to the representative storage place.

### BRIEF DESCRIPTION OF DRAWINGS

Exemplary embodiments of the present invention will -be described in detail based on the following figures, wherein:

FIG. 1 is a configuration diagram conceptually illustrating modules in a configuration example of an exemplary embodiment;

FIG. 2 is an explanatory diagram illustrating a configuration example of a system using the exemplary embodiment;

FIG. 3 is a flowchart illustrating an example of a process performed by the exemplary embodiment;

FIG. 4 is an explanatory diagram illustrating an example of a data structure of an entity file table;

FIG. 5A and FIG. 5B are explanatory diagrams illustrating an example of an entity file table regarded as a target by the exemplary embodiment;

FIG. 6 is an explanatory diagram illustrating an example of a data structure of an aggregation entity file table;

FIG. 7 is an explanatory diagram illustrating an example of a data structure of the identical file table;

FIG. 8 is an explanatory diagram illustrating an example of a data structure of a link file management table;

FIG. 9 is an explanatory diagram illustrating an example of a data structure of a local link file management table;

FIG. 10 is an explanatory diagram illustrating an example of a process performed by the exemplary embodiment;

FIG. 11 is a flowchart illustrating an example of a process performed by the exemplary embodiment;

FIG. 12 is another flowchart illustrating the example of the process performed by the exemplary embodiment;

FIG. 13 is still another flowchart illustrating the example of the process performed by the exemplary embodiment;

FIG. 14 is an explanatory diagram illustrating an example of a data structure of an aggregation access log;

FIG. 15 is an explanatory diagram illustrating an example of a data structure of a holding cost table;

FIG. 16 is an explanatory diagram illustrating an example of a data structure of a requestor count table;

FIG. 17 is a flowchart illustrating an example of another process performed by the exemplary embodiment;

FIG. 18 is an explanatory diagram illustrating an example of another process performed by the exemplary embodiment;

FIG. 19A and FIG. 19B are explanatory diagrams illustrating an example of another process performed by the exemplary embodiment;

FIG. 20A and FIG. 20B are explanatory diagrams illustrating an example of another process performed by the exemplary embodiment;

FIG. 21 is an explanatory diagram illustrating an example of another process performed by the exemplary embodiment;

FIG. 22 is an explanatory diagram illustrating an example of a data structure of a central server application table;

FIG. 23 is a flowchart illustrating an example of another process performed by the exemplary embodiment;

FIG. 24 is a flowchart illustrating an example of another process performed by the exemplary embodiment;

FIG. 25 is an explanatory diagram illustrating an example of a data structure of a aggregation entity file table;

FIG. 26 is an explanatory diagram illustrating an example of a data structure of the identical file table;

FIG. 27 is an explanatory diagram illustrating an example of a data structure of a link file management table; and

FIG. 28 is a block diagram illustrating an example of a hardware configuration of a computer that implements the exemplary embodiment.

### DETAILED DESCRIPTION

Hereinafter, examples of preferred exemplary embodiments in implementing the present invention will be described on the basis of the drawings.

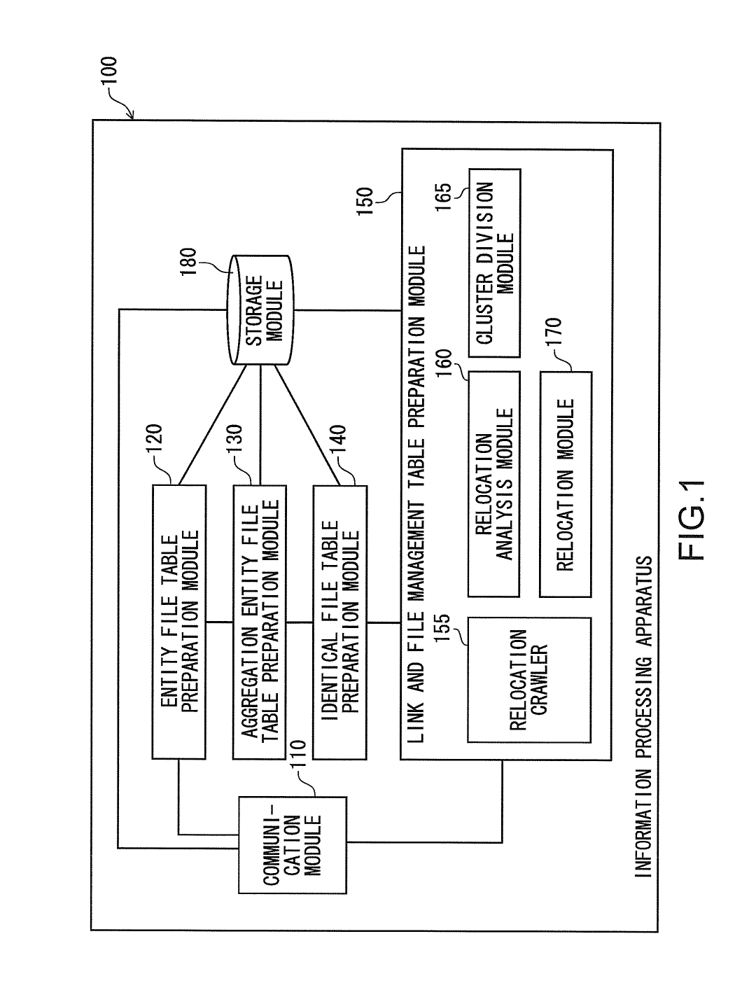

FIG. 1 is a configuration diagram conceptually illustrating modules in a configuration example of the present exemplary embodiment.

A module generally refers to logically divisible pieces of software (a computer program) or hardware or the like. Accordingly, the module in the present exemplary embodiment refers not only to a module in a computer program but also to a module in a hardware configuration. Therefore, in the present exemplary embodiment, a computer program that functions as the modules (a program for causing a computer to execute respective procedures, a program for causing a computer to function as respective units, a program for causing a computer to implement respective functions), a system, and a method are also described.

For the convenience of explanation, the expressions of “stores”, “is stored”, and other expressions equivalent to the expressions are used. However, in a case where an exemplary embodiment is a computer program, these expressions mean that something is caused to be stored in a storage device or control is performed such that something is stored in the storage device.

The module may have a one-to-one correspondence with a function. However, in mounting the modules, a single module may be configured by a single program, plural modules may be configured by a single program, and in an opposite manner, a single module may be configured by plural programs. Furthermore, plural modules may be executed by a single computer or a single module may be executed by plural computers in a distributed or parallel environment. Other modules may be included in a single module.

In the following, the expression “connection” is also used in a case of a logical connection (sending and receiving of data, issuing of instructions, reference relationship between data, or the like) in addition to a physical connection.

The expression “predetermined” is used to include the meaning that matters are determined before processing regarded as a target is performed, and matters are determined on the basis of the situation and the state at that time or determined on the basis of the situation and the state until that time before the processing regarded as the target is performed even after the processing in the present exemplary is started as well as before the processing in the present exemplary embodiment is started. In a case where there are plural “predetermined values”, the predetermined values may be respectively different values or two or more (also including all the values) of the predetermined values may be the identical.

The description signifying that “In a case of A, it is regarded as B” is used to signify that “It is determined whether it is A, and when it is determined that it is A, it is regarded as B”. However, a case where the determination as to whether it is A is unnecessary is excluded.

A system or an apparatus is configured in such a way that plural computers, hardware, apparatuses or the like are connected to each other by a communication unit such as a network (including communication connection on one-to-one correspondence), and may be implemented by a single computer, hardware, apparatus or the like. The “apparatus” and the “system” are interchangeably used herein as having the identical meaning. The “system” does not include a social “mechanism” (a social system) that is merely an artificial arrangement.

A piece of information regarded as a target is read from the storage device for each processing by each module or for each processing in a case where plural processing is performed in the module and a processing result is written into the storage device after the processing is performed. Accordingly, description of the reading from the storage device before the processing and the writing into the storage device after the processing may be omitted. Here, the storage device may include a hard disk, a random access memory (RAM), an external storage medium, a storage device through a communication line, a register within a central processing unit (CPU) or the like.

In the information processing apparatus 100 which is the present exemplary embodiment, the identical document (hereinafter, referred to as a file) is replaced with a link which points to a representative storage place, and as illustrated in an example of FIG. 1, includes a communication module 110, an entity file table preparation module 120, an aggregation entity file table preparation module 130, the identical file table preparation module 140, a link and file management table preparation module 150, and a storage module 180. A document is mainly a piece of text data, and in some cases, a piece of electronic data (may be referred to as a file) such as a figure, an image, a moving image, a voice, or a combination of the pieces of electronic data, becomes a target for storage, editing, retrieval or the like, may be exchanged as an individual unit between systems or between users, and may include a piece of data similar to those pieces of data. Specifically, the document includes a document prepared by a document preparation program, a Web page or the like.

The information processing apparatus 100 manages a relationship between an individual link of the document and an entity of the document. An access right management list for a document may be assigned for each of the separate links.

The communication module 110 is connected with the entity file table preparation module 120, the link and file management table preparation module 150, and the storage module 180. The communication module 110 communicates with a document storage apparatus. Here, the document storage apparatus includes, for example, a document server (hereinafter, may be referred to as a file server), an information processing apparatus used by individuals or the like. The information processing apparatus used by individuals includes, for example, a personal computer (PC), a mobile terminal including a smart phone, or the like.

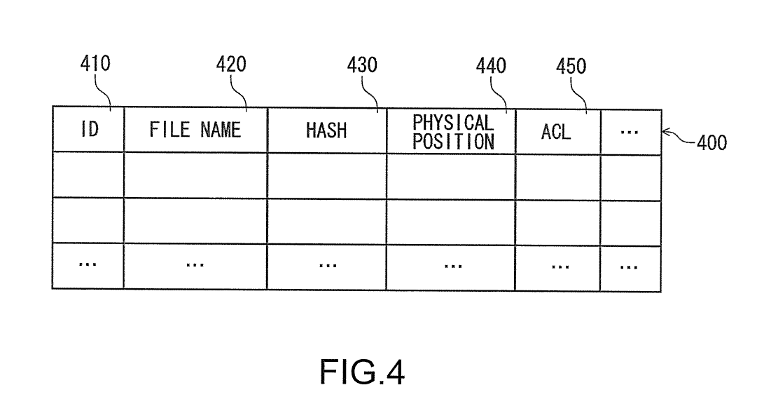

The entity file table preparation module 120 is connected with the communication module 110, the aggregation entity file table preparation module 130, and the storage module 180. The entity file table preparation module 120 manages a piece of information relating to the documents collected by a relocation crawler 155. For example, the entity file table preparation module 120 generates an entity file table 400. FIG. 4 is an explanatory diagram illustrating an example of a data structure of the entity file table 400. The entity file table 400 includes an ID field 410, a file name field 420, a hash field 430, a physical position field 440, and an Access Control List (ACL) field 450. A piece of information (ID: identification) for uniquely identifying each row (file (document)) in the entity file table 400 in the present exemplary embodiment is stored in the ID field 410. A file name is stored in the file name field 420. A hash value of the file is stored in the hash field 430. A physical position of the file is stored in the physical position field 440. An access right management list of the file is stored in the ACL field 450. The entity file table 400 is generated for each apparatus (a node, each user terminal 210, each file server 250 that will be described later) which stores the document. The entity file table 400, which is not generated by the entity file table preparation module 120 but generated by an apparatus which stores the document, may be collected.

The aggregation entity file table preparation module 130 is connected with the entity file table preparation module 120, the identical file table preparation module 140, and the storage module 180. The aggregation entity file table preparation module 130 extracts the identical document stored in storage places of plural document storage apparatuses. For example, the aggregation entity file table preparation module 130 may match contents of corresponding documents with each other to determine whether the corresponding documents are the identical document or not, and calculate a hash value with respect to the documents and extract a document having the identical hash value as the identical document. The document is in a state of being stored in “plural document storage apparatuses” and thus, is in a state of being stored in “plural storage places”. Although the identical document includes a document which exists in plural document storage apparatuses, the identical document includes another document which exists in plural storage places in a single document storage apparatus of plural of document storage apparatuses.

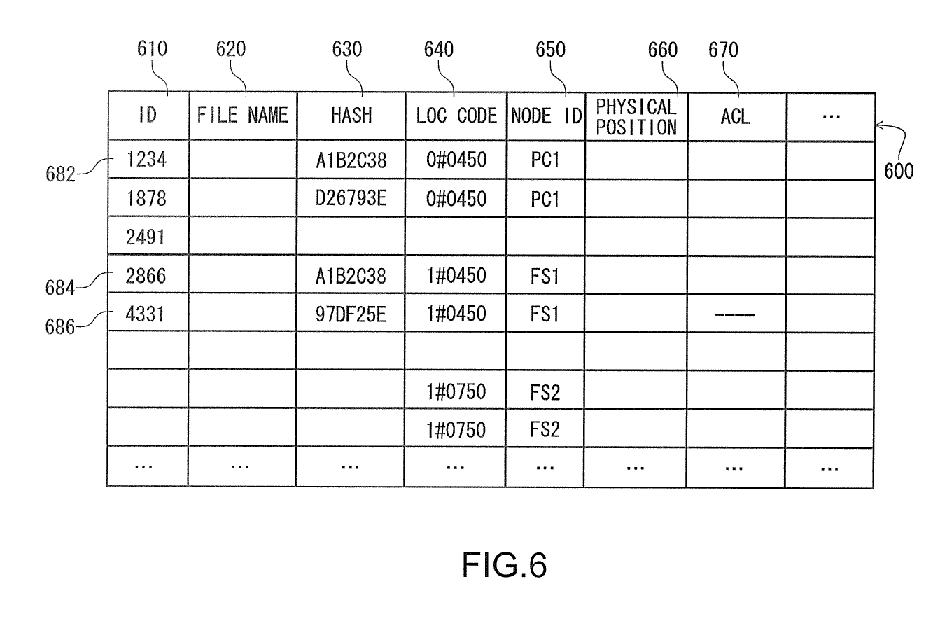

The aggregation entity file table preparation module 130 generates, for example, an aggregation entity file table 600. FIG. 6 is an explanatory diagram illustrating an example of a data structure of the aggregation entity file table 600. The aggregation entity file table 600 includes an ID field 610, a file name field 620, a hash field 630, a LOC code field 640, a node ID field 650, a physical position field 660, and an ACL field 670. A piece of information (ID) for uniquely identifying each row (file (document)) in the aggregation entity file table 600 in the present exemplary embodiment is stored in the ID field 610. A file name is stored in the file name field 620. A hash value of the file is stored in the hash field 630. A LOC code (location code) indicating a position of an apparatus which stores the file is stored in the LOC code field 640. That is, the LOC code indicates a place where the user terminal 210, the file server 250 or the like is placed. For example, “0#0450” indicates the user terminal 210 which is placed in Yokohama, “1#0750” indicates the file server 250 which is placed in Kyoto, and “2#0000” indicates the file server 250 equipped with an archive function. A piece of information (ID) for uniquely identifying an apparatus (a node, specifically, user terminal 210, file server 250) which stores the file in the present exemplary embodiment is stored in the ID field 650. A physical position which is a storage place of the file is stored in the physical position field 660. An access right management list of the file is stored in the ACL field 670.

The identical file table preparation module 140 is connected with the aggregation entity file table preparation module 130, the link and file management table preparation module 150, and the storage module 180.

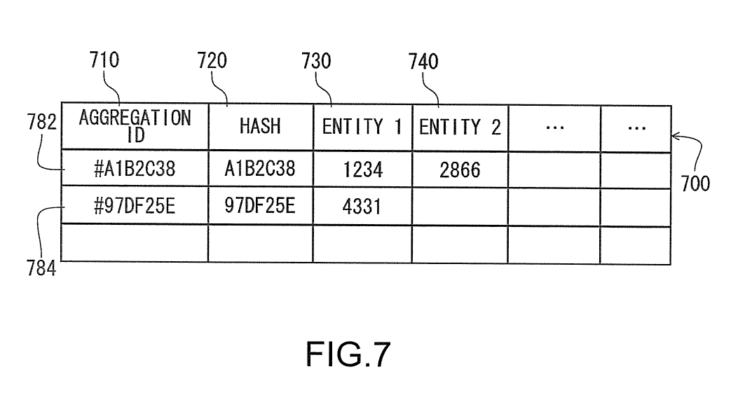

The identical file table preparation module 140 generates, for example, the identical file table 700. FIG. 7 is an explanatory diagram illustrating an example of a data structure of the identical file table 700. The identical file table is obtained by extracting the identical files. The identical file table includes links to entities. The identical file table 700 includes an aggregation ID field 710, a hash field 720, an entity 1 field 730, and an entity 2 field 740. A piece of information (aggregation ID) for uniquely identifying each row in the identical file table 700 in the present exemplary embodiment is stored in the ID field 710. A hash value of the file is stored in the hash field 720. An entity 1 ID (contents of the ID field 610 of the aggregation entity file table 600) is stored in the entity 1 field 730. An entity 2 ID (contents of the ID field 610 of the aggregation entity file table 600) is stored in the entity 2 field 740. In the identical file table 700, the entity 2 ID may be followed by a field equivalent to the entity 1 field 730.

The link and file management table preparation module 150 includes a relocation crawler 155, a relocation analysis module 160, a cluster division module 165, and a relocation module 170, and is connected with the communication module 110, the identical file table preparation module 140, and the storage module 180.

The relocation crawler 155 communicates with plural document storage apparatuses through the communication module 110 and collects the document or the hash value of the documents. The document or the hash value may be collected regularly plural times. The processing by the entity file table preparation module 120 is performed. The relocation crawler 155 may collect a history of access to the document. In a case where the hash value is calculated in the document storage apparatus side, the relocation crawler 155 collects the hash value of the document.

The relocation analysis module 160 determines a representative storage place, which is a representative storage place, of plural storage places.

The relocation analysis module 160 may determine the representative storage place using the history of access to the document.

The relocation analysis module 160 generates, for example, a link file management table 800 or a local link file management table 900. The link file management table 800 is prepared using the file server 250 and indicates which file entity each link, which exists in each file server 250, points to.

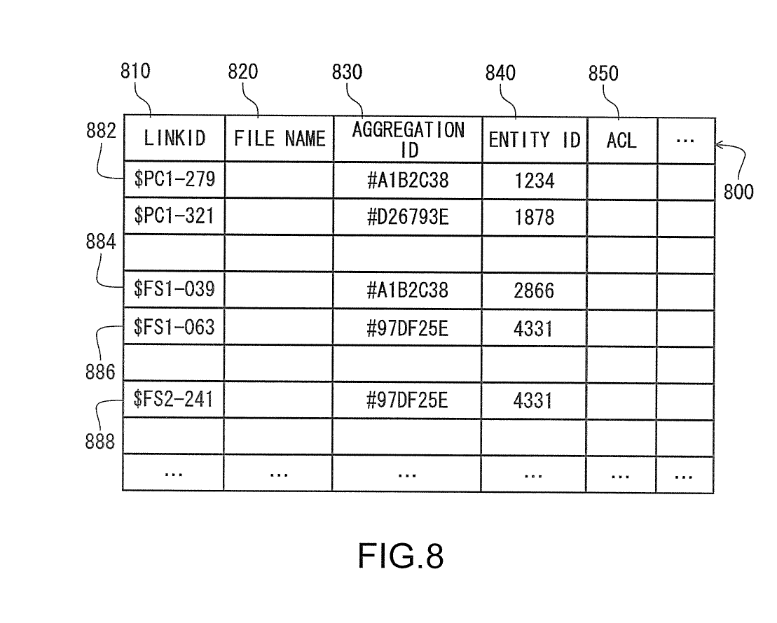

FIG. 8 is an explanatory diagram illustrating an example of a data structure of a link file management table 800. The link file management table 800 includes a Link ID field 810, a file name field 820, an aggregation ID field 830, an entity ID field 840, and an ACL field 850. A piece of information (Link ID) for uniquely identifying each row of the link file management table 800 is stored in the Link ID field 810. The file name is stored in the file name field 820. An aggregation ID (contents of the aggregation ID field 710 of the identical file table 700) is stored in the aggregation ID field 830. An entity ID (contents of the ID field 610 of the aggregation entity file table 600) is stored in the entity ID field 840. An access right management list of the entity (file) is stored in the ACL field 850.

The local link file management table 900 is prepared using the user terminal 210 and indicates which file entity each link, which exists in each user terminal 210, points to.

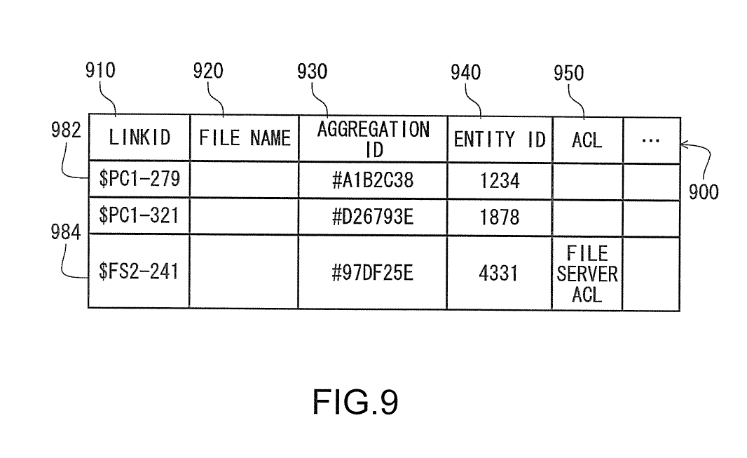

FIG. 9 is an explanatory diagram illustrating an example of a data structure of a local link file management table 900. The local link file management table 900 includes a Link ID field 910, a file name field 920, an aggregation ID field 930, an entity ID field 940, and an ACL field 950. A piece of information (Link ID) for uniquely identifying each row in the local link file management table 900 is stored in the Link ID field 910. The file name is stored in the file name field 920. An aggregation ID (contents of the aggregation ID field 710 of the identical file table 700) is stored in the aggregation ID field 930. An entity ID (contents of the ID field 610 of the aggregation entity file table 600) is stored in the entity ID field 940. An access right management list of the entity (file) is stored in the ACL field 950.

The cluster division module 165 adopts plural storage places with respect to the identical document as a target and generates a set (hereinafter, referred to as a cluster) of plural storage places.

The relocation analysis module 160 may use a history of access in a storage place of the cluster which corresponds to a processing result by the cluster division module 165 to determine the representative storage place within the cluster. The representative storage place may be generated for each cluster. Accordingly, in a case where plural clusters exist, plural representative storage places are generated.

The relocation module 170 replaces a document which exists in a storage place other than the representative storage place with a link which points to the representative storage place. That is, an entity of the document is stored in the representative storage place, and a document other than the document, of which entity is stored, is replaced with the link which points to the representative storage place. A single or plural representative storage places may exist.

The relocation module 170 gives an access right management list of the document to each link. Here, the “access right management list” is also referred to as an access control list (ACL) and refers to a list in which access authority to the document of a user (including a group consisting of plural users) are enumerated. When an instruction to operate a document is issued from the user, an access right management list of the document is collated, an examination as to whether a proper right is present is performed, and a determination as to whether execution of the operation is allowed or not is performed.

The access right management list is provided for each link and is not unified between the identical documents. For example, in a case where the document shared by the group A is copied and is used to be shared in the group B by a new access right management list, the access right management list is assigned to each link such that the entity of the document may not be copied.

The storage module 180 is connected with the communication module 110, the entity file table preparation module 120, the aggregation entity file table preparation module 130, the identical file table preparation module 140, and the link and file management table preparation module 150. The storage module 180 stores a file collected by the relocation crawler 155 or a hash value of the file, the entity file table 400, the aggregation entity file table 600, the identical file table 700, the link file management table 800, the local link file management table 900, or the like.

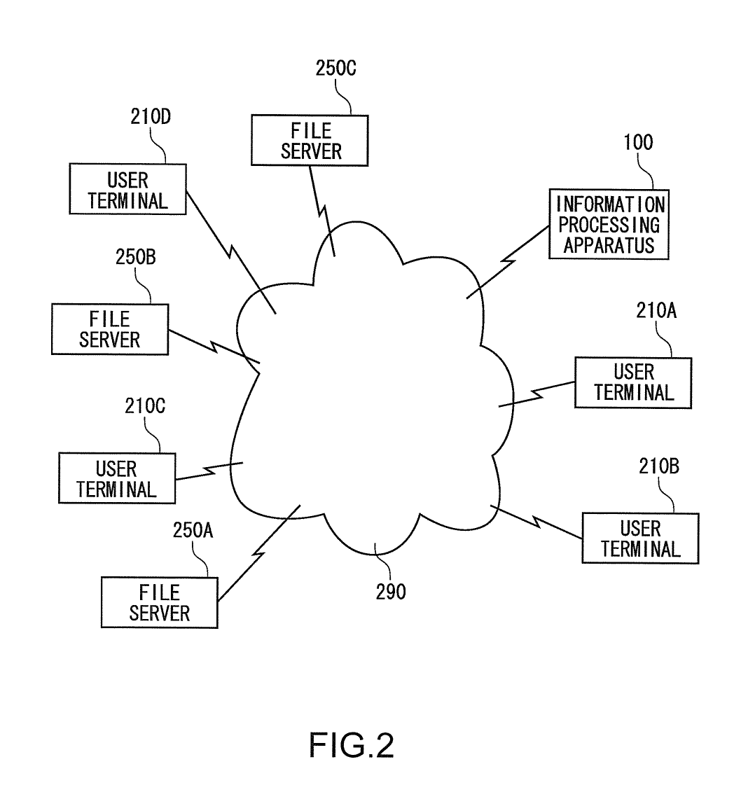

FIG. 2 is an explanatory diagram illustrating a configuration example of a system using the present exemplary embodiment.

The information processing apparatus 100, a user terminal 210A, a user terminal 210B, a user terminal 210C, a user terminal 210D, a file server 250A, a file server 250B, and a file server 250C are connected to each other through a communication line 290. The communication line 290 may be a wired communication network, a wireless communication network, or a combination of the wired communication network and the wireless communication network, and may be, for example, the Internet and the Ethernet as a communication infrastructure. The user terminal 210 and the file server 250 may be dispersed geographically. For example, the user terminal 210 and the file server 250 may be located in Tokyo, Osaka, or the like and may be dispersed globally. The function by the information processing apparatus 100 and the file server 250 may be implemented as a cloud service. The information processing apparatus 100 regards files within each user terminal 210 and each file server 250 as a target. The relocation crawler 155 collects the files within each user terminal 210 and each file server 250 using a function as a crawler. The relocation crawler 155 may cause the hash value of the file to be calculated in each user terminal 210 and each file server 250 and collect the hash value. The relocation crawler 155 may cause the entity file table 400 to be generated in each user terminal 210 and each file server 250 and collect the entity file table 400.

In the user terminal 210, a difference in use between the entity of the document and the link is prevented by a user interface such as a browser. That is, a differentiation in displaying is not made between the document (entity) which exists in the user terminal 210 and a document (a link in the user terminal 210) which exists in a different place (other user terminal 210 and other file server 250) which is not the user terminal 210. Accordingly, the entity of document and the link of document may be viewed in a unifying shape and there is no need to worry about the storage place of the entity.

The user terminal 210 may be configured by including the information processing apparatus 100 or the file server 250 may be configured by including the information processing apparatus 100.

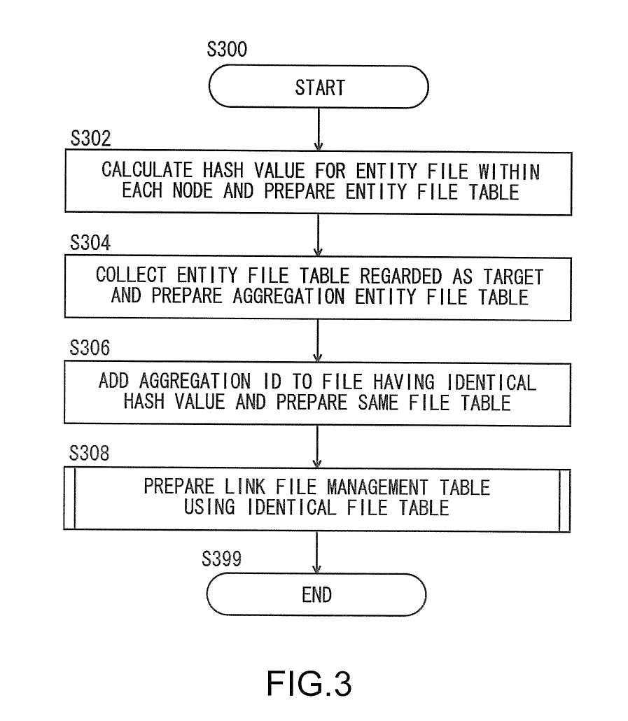

FIG. 3 is a flowchart illustrating an example of a process performed by the exemplary embodiment.

In Step S302, the entity file table preparation module 120 calculates a hash value for entity files within each node and prepares an entity file table 400.

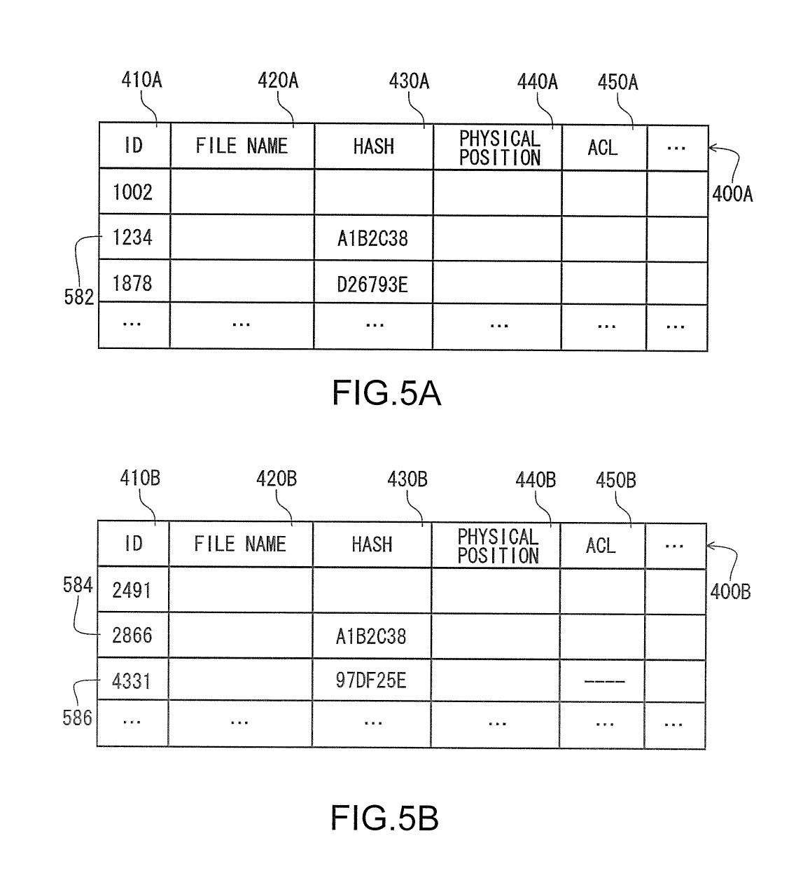

Specifically, the entity file table preparation module 120 prepares the entity file table 400A illustrated in the example of FIG. 5A and the entity file table 400B illustrated in the example of FIG. 5B. The entity file table 400A is prepared by using the files within the user terminal 210A as a target and the entity file table 400B is prepared by using the files within the file server 250A.

The entity file tables 400A and 400B indicate a state, as a result of a comparison of the hash values (values within the hash field 430A and hash field 430B), where a file of a target row 582 (ID: 1234) of the entity file table 400A and a file of a target row 584 (ID: 2866) of the entity file table 400B are the identical but are not shared.

A target row 586 (ID: 4331) within the entity file table 400B corresponds to a file which is shared. The symbol “----” within the ACL field 450B indicates the ACL which is shared.

In Step S304, the aggregation entity file table preparation module 130 collects the entity file tables 400 being targets and prepares an aggregation entity file table 600.

Specifically, the aggregation entity file table 600 illustrated in the example of FIG. 6 is obtained by merging the entity file table 400A illustrated in the example of FIG. 5A and the entity file table 400B illustrated in the example of FIG. 5B. The ID field 610, the file name field 620, the hash field 630, the physical position field 660, and the ACL field 670 correspond respectively to the ID field 410, the file name field 420, the hash field 430, the physical position field 440, the ACL field 450 of the entity file table 400. The node ID field 650 indicates an apparatus in which the file is stored (specifically, the user terminal 210A for the entity file table 400A, and the file server 250A for the entity file table 400B, or the like). A target row 682, a target row 684, a target row 686 respectively correspond to the target row 582, the target row 584, and the target row 586.

In Step S306, the identical file table preparation module 140 adds an aggregation ID to files having the identical hash values and prepares the identical file table 700.

Specifically, the identical file table 700 illustrated in the example of FIG. 7 is prepared from the aggregation entity file table 600. The target row 782 is generated from the target row 682 and the target row 684. The target row 784 is generated from the target row 686.

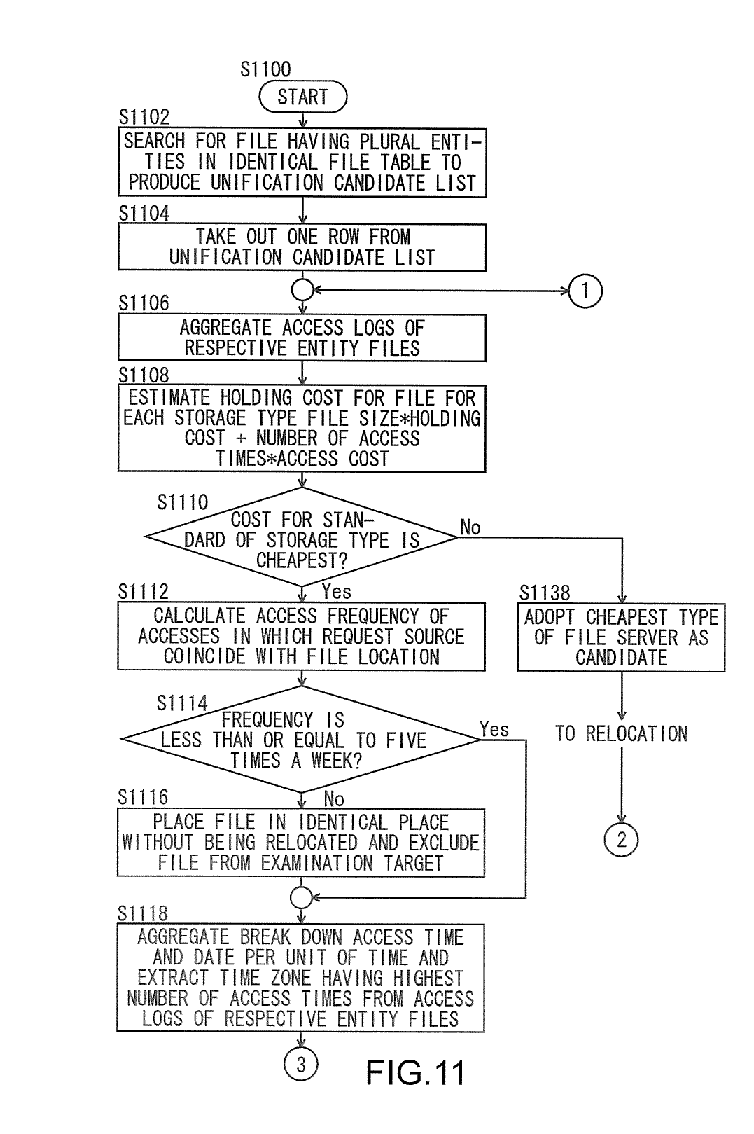

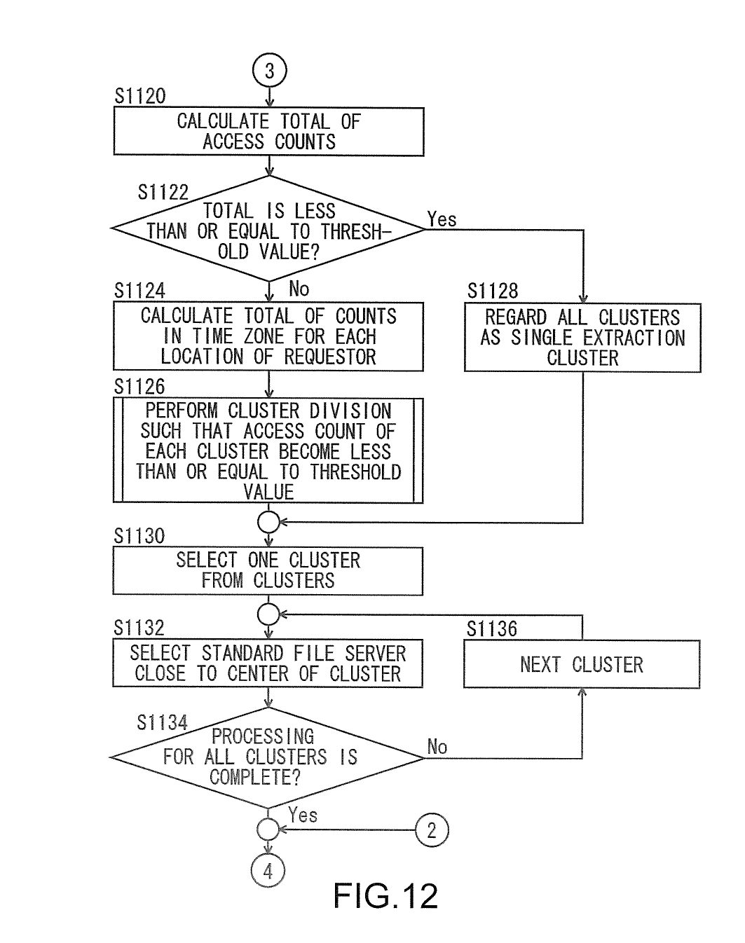

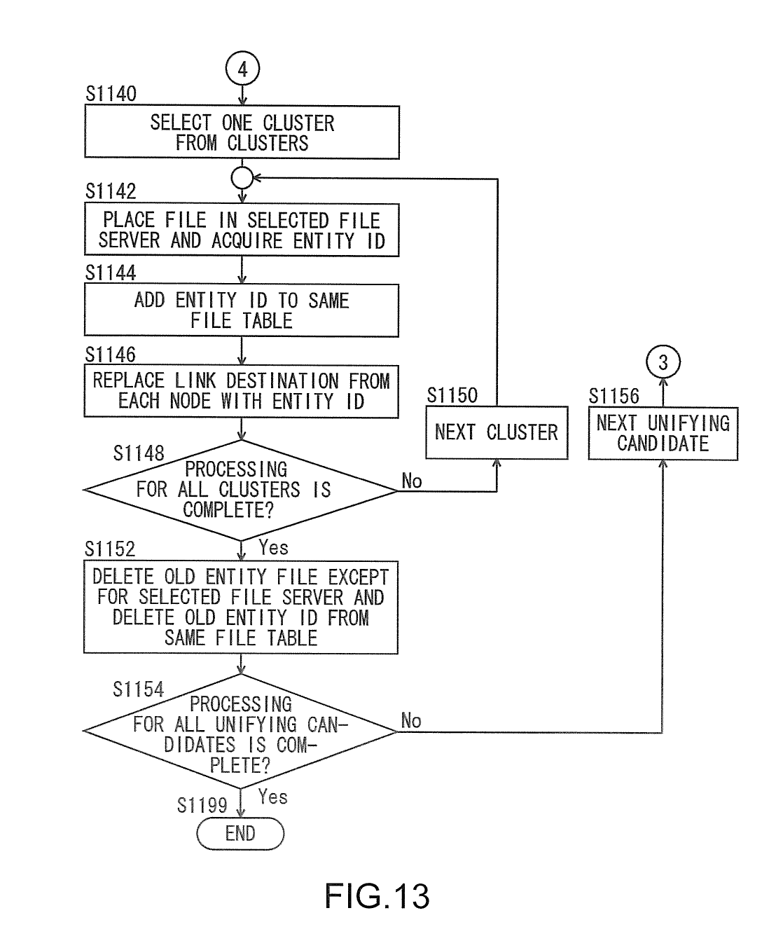

In Step S308, the link and file management table preparation module 150 prepares a link file management table 800 or a local link file management table 900 using the identical file table 700. Details of the process will be described later using the flowcharts illustrated in FIG. 11 to FIG. 13. The link file management table 800 illustrated in the example of FIG. 8 and the local link file management table 900 illustrated in the example of FIG. 9 are prepared from the identical file table 700. The link file management table 800 is transmitted to the file server 250A and the local link file management table 900 is transmitted to the user terminal 210A.

A target row 882 (entity ID: 1234) and a target row 884 (entity ID: 2866) of the link file management table 800 are the identical but, are not in a state of being shared. A target row 886 (entity ID: 4331) and a target row 888 (entity ID: 4331) are files being shared. A different ACL is provided for each file. That is, the ACL is given to each link and thus, the entity may not be copied.

It is indicated, in the target row 982 of the local link file management table 900, that the entity of the file exists in the user terminal 210A. It is indicated, in the target row 984, that the entity of the file exists in the file server 250A and the ACL exists in the file server 250A.

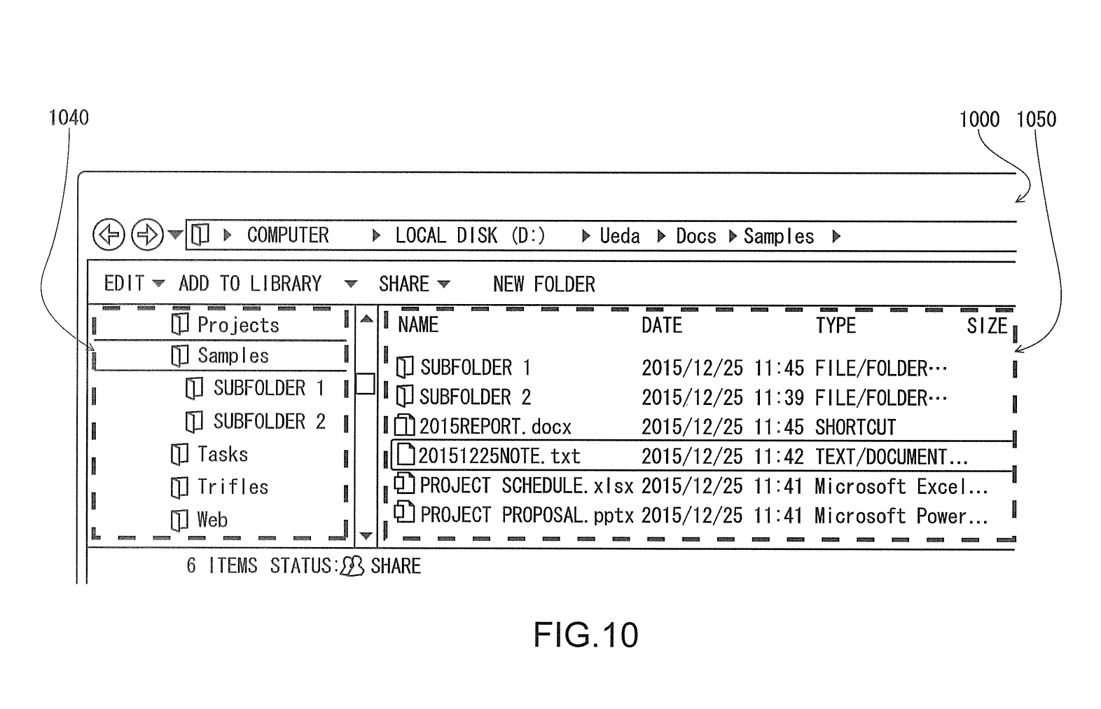

FIG. 10 is an explanatory diagram illustrating an example of a process performed by the exemplary embodiment.

For example, the user terminal 210 displays an access screen 1000 using the local link file management table 900. The access screen 1000 includes a folder list display area 1040 and a file list display area 1050. In the folder list display area 1040, the folders are displayed in a tree structure and in the file list display area 1050, files within the folder designated in the folder list display area 1040 are displayed in a list.

That is, the link (local link file management table 900 and link file management table 800) is held in each node (user terminal 210 and file server 250). The link may be used to perform an operation such as displaying of a file list, opening of the file, or the like.

FIG. 11 to FIG. 13 are flowcharts illustrating an example of a process performed by the exemplary embodiment.

In Step S1102, the identical file table 700 is searched for a file having plural entities. A unification candidate list having plural entities as contents is generated.

In Step S1104, one row is taken out from the unification candidate list.

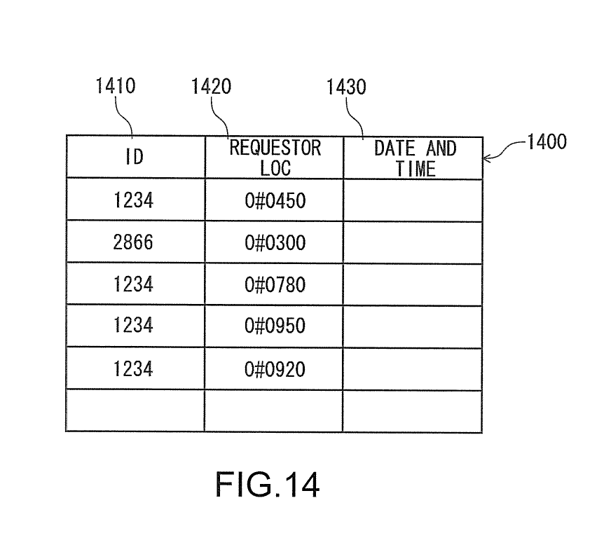

In Step S1106, access logs of respective entity files are aggregated. Each user terminal 210 collects an access log of a document from each file server 250 and for example, generates an aggregation access log 1400. FIG. 14 is an explanatory diagram illustrating an example of an aggregation access log 1400. The aggregation access log 1400 includes an ID field 1410, a requestor LOC field 1420, and a date and time field 1430. A piece of information (ID) for uniquely identifying each row within the aggregation access log 1400 in the present exemplary embodiment is stored in the ID field 1410. A LOC code of the user terminal 210 (may be file server 250) which requests an access is stored in the requestor LOC field 1420. A date and time at which the access is performed (year, month, day, time, minute, second, smaller unit than the second, or a combination thereof) is stored in the date and time field 1430.

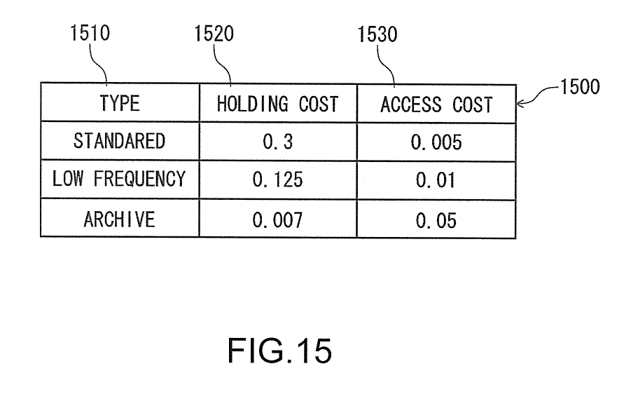

In Step S1108, a trial calculation of a holding cost for a file is made for each storage type. For example, the holding cost is calculated by, “file size*holding cost+number of access times*access cost”. The holding cost and the access cost are different depending on the storage type and thus, for example, defined by a holding cost table 1500. FIG. 15 is an explanatory diagram illustrating an example of a data structure of the holding cost table 1500. The holding cost table 1500 includes a type field 1510, a holding cost field 1520, and an access cost field 1530. The storage type is stored in the type field 1510. The holding cost in the storage type is stored in the holding cost field 1520. The access cost in the storage type is stored in the access cost field 1530.

In Step S1110, it is determined whether a cost for a standard of a storage type is the cheapest or not. In a case where the cost for a standard of a storage type is the cheapest, the process proceeds to Step S1112 and otherwise, the process proceeds to Step S1138.

In Step S1112, an access frequency of accesses in which the requestor coincides with the file location is calculated.

In Step S1114, it is determined whether the frequency is less than or equal to five times a week. In a case where the frequency is less than or equal to five times a week, the process proceeds to Step S1118 and otherwise, the process proceeds to Step S1116. The five times as the threshold value is an example of a predetermined value and a numerical value other than the five times may be used.

In Step S1116, the file is placed in the identical storage place without being relocated and is excluded from an examination target.

In Step S1118, an access date and time is break down per units of time and a period of time having the highest number of access times is extracted.

In Step S1120, a total number of access counts is calculated.

In Step S1122, it is determined whether the total number of access counts is less than or equal to a threshold value. In a case where the total number of access counts is less than or equal to the threshold value, the process proceeds to Step S1128 and otherwise, the process proceeds to Step S1124. Here, the threshold value is a predetermined value.

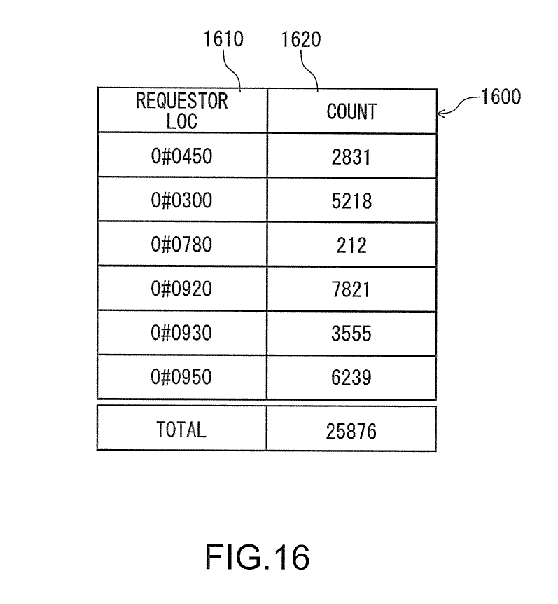

In Step S1124, a total number of counts of in the period of time is calculated for each position of a requestor. For example, the requestor count table 1600 is generated. FIG. 16 is an explanatory diagram illustrating an example of a data structure of the requestor count table 1600. The requestor count table 1600 includes a requestor LOC field 1610 and a count field 1620. The LOC code of an apparatus (user terminal 210 and file server 250) that performs an access request is stored in the requestor LOC field 1610. The count value of accesses by the apparatus is stored in the count field 1620. In FIG. 16, a total of the count values is indicated in the last row.

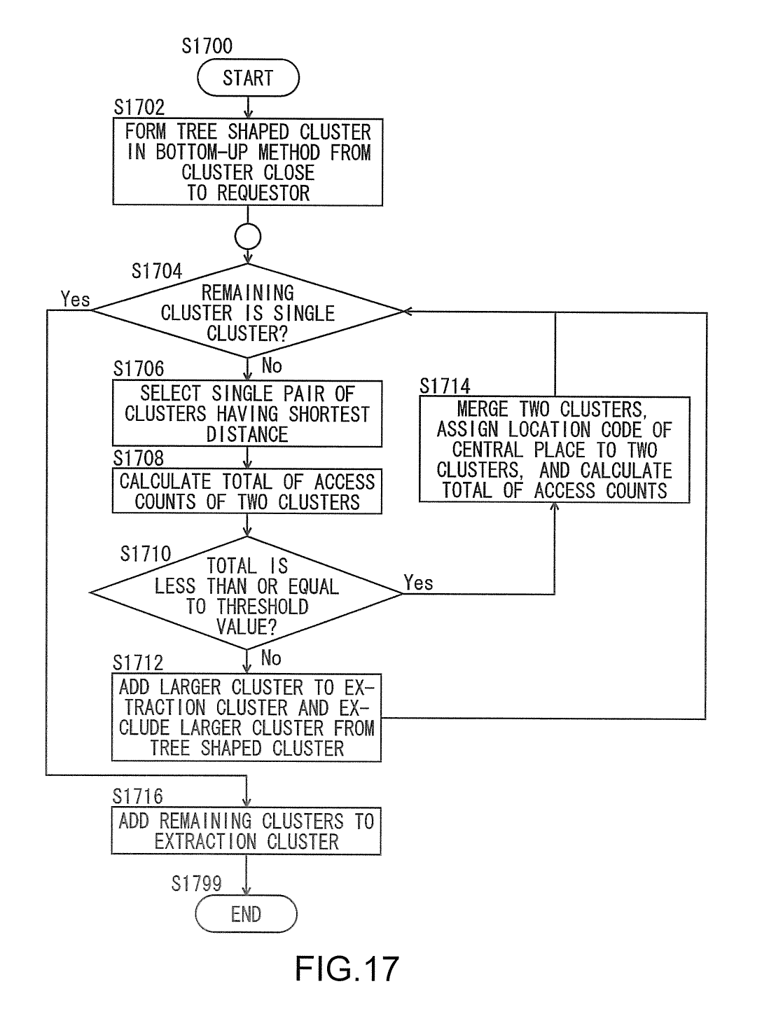

In Step S1126, the cluster division is performed such that an access count of each cluster becomes less than or equal to the threshold value. The cluster division will be described later using a flowchart illustrated in the example of FIG. 17. Here, the threshold value is a predetermined value.

In Step S1128, all clusters are regarded as a single extraction cluster and the process proceeds to Step S1130.

In Step S1130, one cluster is selected from the clusters.

In Step S1132, a standard file server close to the center of the cluster is selected.

In Step S1134, it is determined whether processing for all clusters is ended or not. In a case where the processing for all cluster is ended, the process proceeds to Step S1140, and otherwise, the process proceeds to Step S1136.

In Step S1136, the next cluster is adopted as a target and the process proceeds to Step S1132.

In Step S1138, the cheapest type file server is adopted as a candidate and the process proceeds to Step S1140.

In Step S1140, one cluster is selected from the clusters.

In Step S1142, the file is placed in the selected file server and an entity ID is acquired.

In Step S1144, the entity ID is added to the identical file table.

In Step S1146, a link destination from each node is replaced with the entity ID.

In Step S1148, it is determined whether processing for all clusters is ended or not. In a case where the processing for all clusters is ended, the process proceeds to Step S1152, and otherwise, the process proceeds to Step S1150.

In Step S1150, the next cluster is adopted as a target and the process returns to Step S1142.

In Step S1152, the old entity file is deleted except for the selected file server and the entity ID is deleted from the identical file table.

In Step S1154, it is determined whether processing for all unifying candidates is ended or not. In a case where the processing for all unifying candidates is ended, the process is ended (Step S1199), and otherwise, the process proceeds to Step S1156.

In Step S1156, the next unifying candidate is adopted as a target and the process returns to Step S1106.

FIG. 17 is a flowchart illustrating an example of a process performed by the exemplary embodiment. FIG. 17 illustrates details of the process in Step S1126 (cluster division process) described above.

In Step S1702, a cluster close to the access requestor forms a tree shaped cluster first in a bottom-up method.

In Step S1704, it is determined whether the remaining cluster is a single cluster or not. In a case where the remaining cluster is a single cluster, the process proceeds to Step S1716, and otherwise, the process proceeds to Step S1706.

In Step S1706, a single pair of clusters having the shortest distance is selected.

In Step S1708, a total of access counts of two clusters is calculated.

In Step S1710, it is determined whether the total of access counts is less than or equal to a threshold value or not. In a case where the total of access counts is less than or equal to the threshold value, the process proceeds to Step S1714 and otherwise, the process proceeds to Step S1712. Here, the threshold value is a predetermined value.

In Step S1712, a larger cluster is added to the extraction cluster and is excluded from the tree shaped cluster. Then, the process returns to Step S1704.

In Step S1714, two clusters are merged and a location code of a central place is assigned. The total of access counts is calculated. Then, the process returns to Step S1704.

In Step S1716, the remaining clusters are added to the extraction cluster.

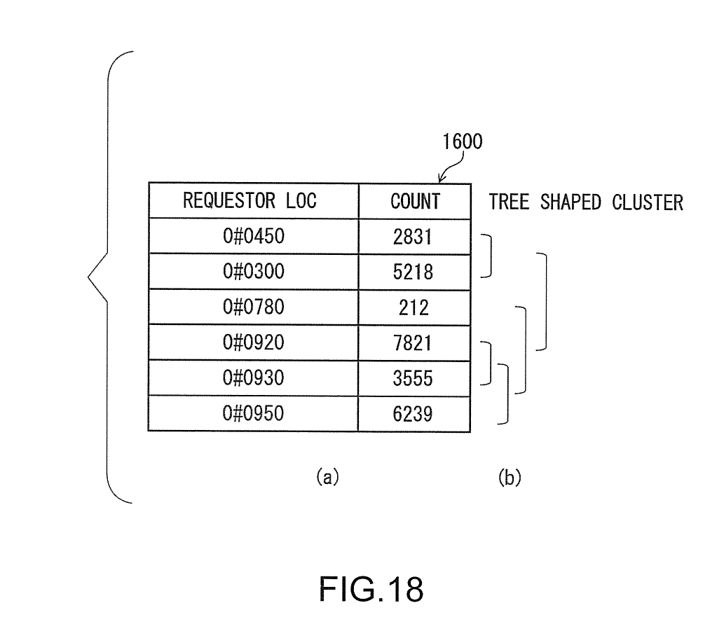

The cluster division process will be described using a specific example illustrated in FIG. 18 to FIG. 22.

The process in Step S1702 is as follows.

FIG. 18 illustrates the formation of a tree shaped cluster illustrated in the example of section (b) shown in FIG. 18 with respect to the requestor count table 1600 illustrated in the example of section (a) shown in FIG. 18. A cluster A is formed by the fourth row and the fifth row, a cluster B is formed by the first row and the second row in the requestor count table 1600, a cluster C is formed by the sixth row and the cluster A, a cluster D is formed by the third row and the cluster C, and a cluster E is formed by the cluster B and the cluster D. The expression “close to an access requestor” refers that a position of an apparatus which requests an access is located in a close distance position and a distance used for determining whether the apparatus is located in the close distance position may be a distance (distance on the map) between locations at which the apparatuses are installed, and may be a topological distance (for example, a hop number indicating the number of relaying facilities to be passed through before arriving a communication counterpart) on a communication line.

The processing from Step S1704 to Step S1714 is as follows.

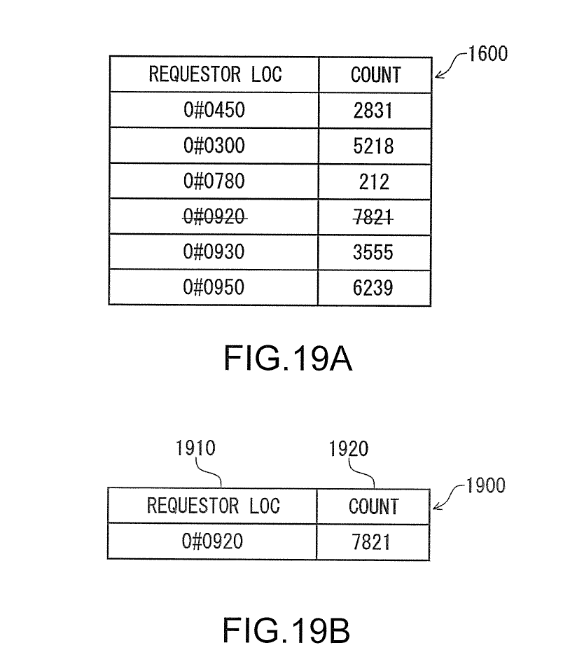

In FIG. 19A and FIG. 19B, in the first loop, a pair of the fourth row and the fifth row (cluster A) corresponds to a relevant item in the requestor count table 1600 illustrated in the example of FIG. 18. When the count number of the fourth row (0#0920) and the count number of the fifth row (0#0930) are merged, the total of access counts exceeds the threshold value (for example, here, becomes “10000”). Accordingly, the fourth row (#0920) is extracted and an extraction cluster table 1900 illustrated in the example of FIG. 19B is generated.

The processing in the next loop is as follows.

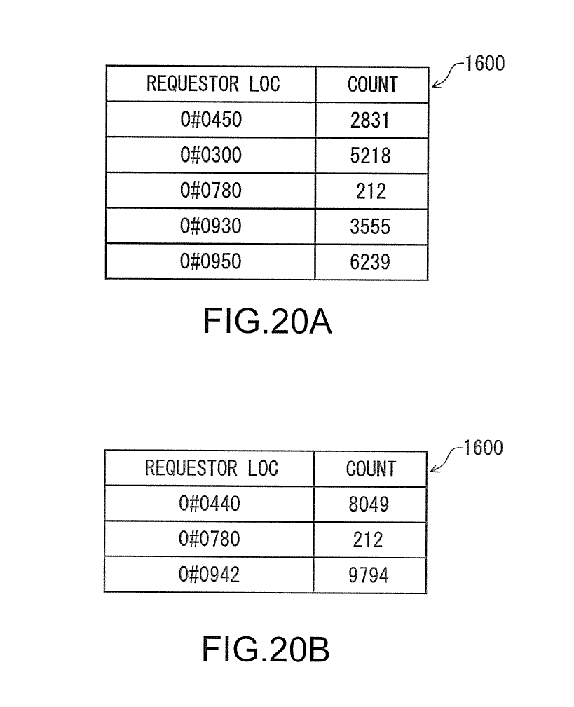

The requestor count table 1600 illustrated in the example of FIG. 20A is obtained by deleting the fourth row (0#0920) of the requestor count table 1600 illustrated in the example of section (a) shown in FIG. 18.

The requestor count table 1600 illustrated in the example of FIG. 20B is obtained merging by merging the first row and the second row and merging the fourth row and the fifth row of the requestor count table 1600 illustrated in the example of FIG. 20A. Each of the totals of access counts of the former merging and the latter merging is less than or equal to the threshold value and thus, respective location codes of central places (0#0440, 0#0942) are given. Thus, the requestor count table 1600 illustrated in the example of FIG. 20B is generated.

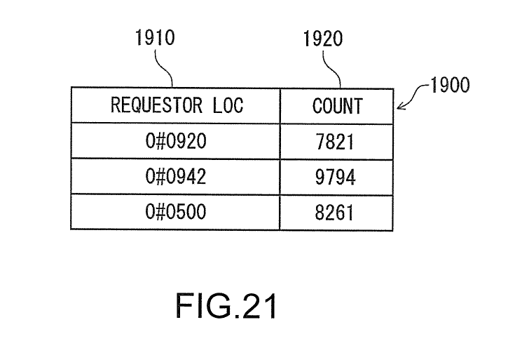

Next, when the count number of the second row (0#0780) and the third row (0#0942) of the requestor count table 1600 illustrated in the example of FIG. 20B are merged, the total of access counts exceeds the threshold value. Accordingly, the third row (0#0942) is extracted and the second row of an extraction cluster table 1900 illustrated in the example of FIG. 21 is generated. When the count numbers of the first row (0#0440) and the second row (0#0780) of the requestor count table 1600 illustrated in the example of FIG. 20B are merged, the total of access counts is less than or equal to the threshold value and thus, a location code of a central place (0#0500) is given. Thus, the extraction cluster table 1900 illustrated in the example of FIG. 21 is generated.

The processing in Step S1716 is as follows.

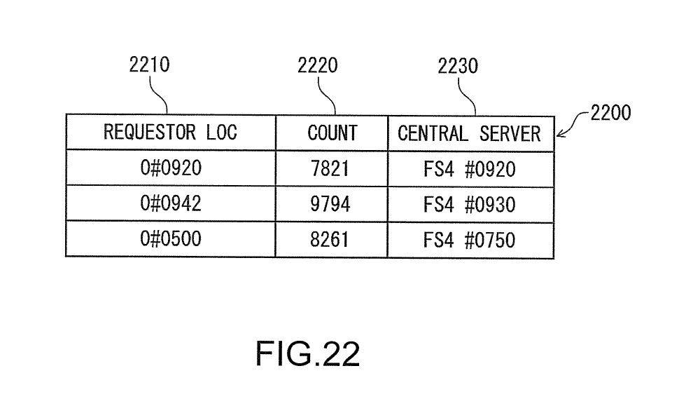

FIG. 22 is an explanatory diagram illustrating an example of a data structure of a central server application table 2200.

The central server application table 2200 is obtained by adding a central server field 2230 to the extraction cluster table 1900 illustrated in the example of FIG. 21. The central server application table 2200 includes a requestor LOC field 2210, a count field 2220, and a central server field 2230. A requestor LOC is stored in the requestor LOC field 2210. A count is stored in the count field 2220. A file server which is closest to the requestor LOC which is a central place of the requestor is allocated to a central server of the central server field 2230. When the file server does not exist in, for example, an area close to a position of 0#0500, FS2#0750 which is the file server closest among the file servers is selected. The entity of the document is placed in the file server. The entity document in other apparatus (user terminal 210) in the cluster in which the file server is included is replaced by the link to the entity.

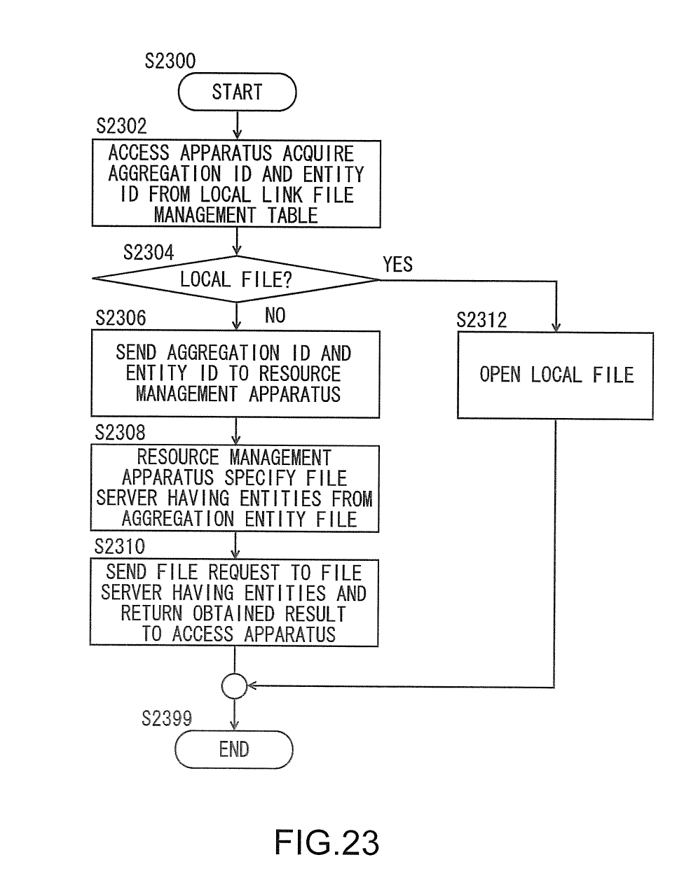

FIG. 23 is a flowchart illustrating an example of a process (an example of a process of accessing to a file) performed by the exemplary embodiment. For example, accessing the file include selecting of a link having a link ID: $FS2-241 by a user, issuing of a browsing command by a user or the like in the user terminal 210 including the information processing apparatus 100.

In Step S2302, the user terminal 210 which is access apparatus acquires the aggregation ID and the entity ID from the local link file management table regarding the file regarded as being an access target.

In Step S2304, it is determined whether the file regarded as being an access target in Step S2302 is the local file or not (whether the entity exists within the user terminal 210 or not). In a case where the file is the local file, the process proceeds to Step S2312 and otherwise, the process proceeds to Step S2306.

In Step S2306, the aggregation ID and the entity ID are sent to the information processing apparatus 100 which is the resource management apparatus.

In Step S2308, the information processing apparatus 100 which is the resource management apparatus specifies the file server 250 having entities from the aggregation entity file.

In Step S2310, a file request is sent to the file server 250 having entities and an obtained result is returned to the user terminal 210.

In Step S2312, the local file within the user terminal 210 is open. Then, the process is ended (Step S2399).

A file edition process or a file update process includes a case of editing a file s a copy for itself and a case of updating the file to be used in common. Whether the copied file and updated file is saved by a different name or saved by being overwritten with respect to the link is determined by an operation of a user.

In a case of being saved by a different name, an entity is placed in a place (file server 250 or user terminal 210) for an entity determined by a user and a new entry is prepared in the entity file table, the identical file table, and the link file management table.

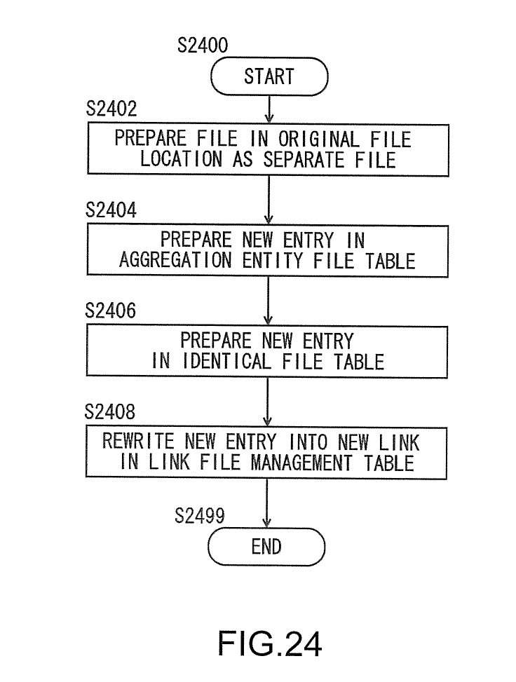

In a case of being saved by overwriting, the processing in line with the flowchart illustrated in the example of FIG. 24 is performed.

FIG. 24 is a flowchart illustrating an example of another process (file edition process or file update process) of performed by the exemplary embodiment.

In Step S2402, a file is prepared in the original file location as a separate file.

In Step S2404, a new entry is prepared in the aggregation entity file table.

In Step S2406, a new entry is prepared in the identical file table.

In Step S2408, a new entry is rewritten into a new link in the link file management table. When a link correlated with the old aggregation ID becomes absent, the link is deleted from the identical file table.

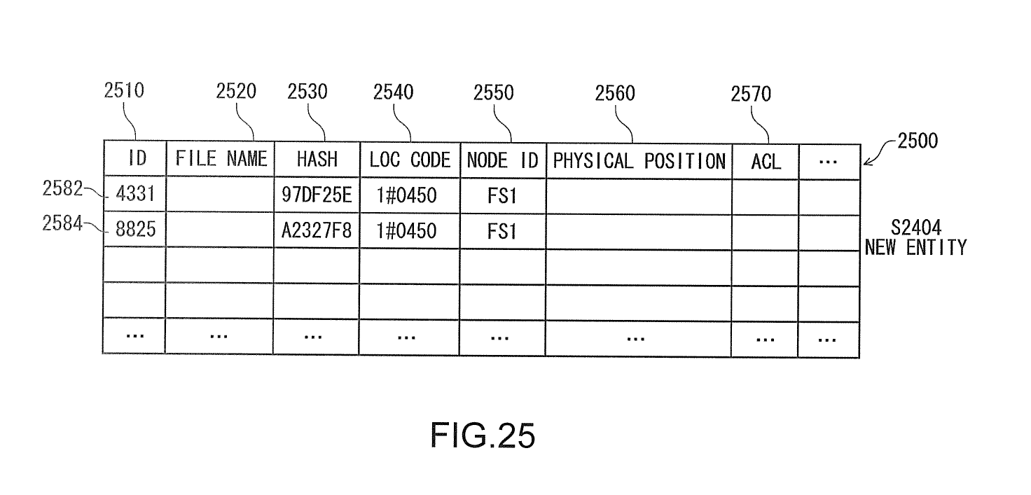

Next, the process illustrated in the example of FIG. 24 will be described using a specific example illustrated in FIG. 25 to FIG. 27.

The file having a Link ID: $FS1-063 and the file having a Link ID: $FS2-241 are separate files that indicate the identical entity (entity ID: 4331). Here, the file having the Link ID: $FS1-063 is regarded as a file to be rewritten.

FIG. 25 is an explanatory diagram illustrating an example of a data structure of an aggregation entity file table 2500.

The aggregation entity file table 2500 is configured by the data equivalent to those of the aggregation entity file table 600 illustrated in the example of FIG. 6. The aggregation entity file table 2500 includes an ID field 2510, a file name field 2520, a hash field 2530, an LOC code field 2540, a node ID field 2550, a physical position field 2560, and an ACL field 2570. An ID is stored in the ID field 2510. A file name is stored in the file name field 2520. A hash is stored in the hash field 2530. An LOC code is stored in the LOC code field 2540. A node ID is stored in the node ID field 2550. A physical position is stored in the physical position field 2560. An ACL is stored in the ACL field 2570.

In the processing of Step S2404, the second row (target row 2584) of the aggregation entity file table 2500 is prepared.

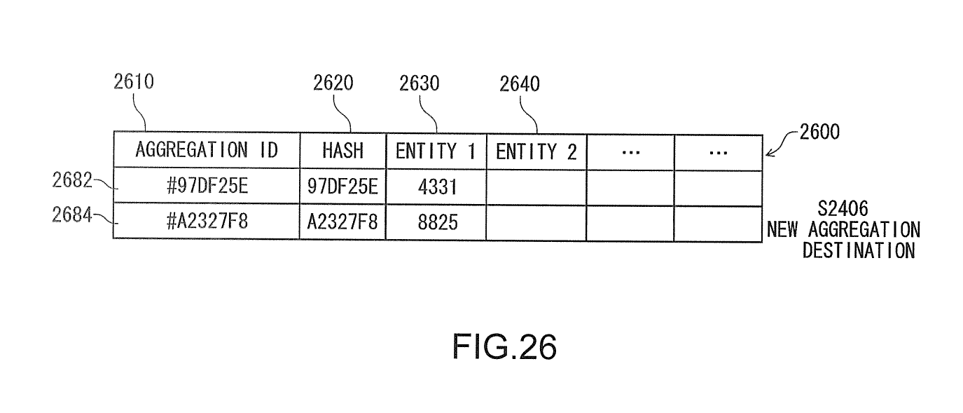

FIG. 26 is an explanatory diagram illustrating an example of a data structure of the identical file table 2600. The identical file table 2600 is configured by the data equivalent to those of the identical file table 700 illustrated in the example of FIG. 7. The identical file table 2600 includes an aggregation ID field 2610, a hash field 2620, an entity 1 field 2630, and an entity 2 field 2640. An aggregation ID is stored in the aggregation ID field 2610. A hash is stored in the hash field 2620. An entity 1 ID is stored in the entity 1 field 2630. An entity 2 ID is stored in the entity 2 field 2640.

In the processing of Step S2406, the second row (target row 2684) of the identical file table 2600 is prepared.

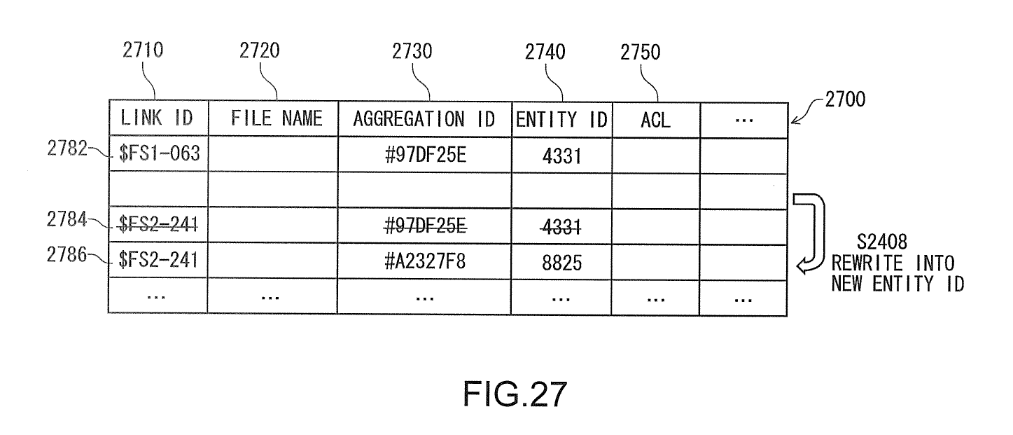

FIG. 27 is an explanatory diagram illustrating an example of a data structure of the link file management table 2700. The link file management table 2700 is configured by the data equivalent to those of the link file management table 800 illustrated in the example of FIG. 8. The link file management table 2700 includes a Link ID field 2710, a file name field 2720, an aggregation ID field 2730, an entity ID field 2740, and an ACL field 2750. A Link ID is stored in the Link ID field 2710. A file name is stored in the file name field 2720. An aggregation ID is stored in the aggregation ID field 2730. An entity ID is stored in the entity ID field 2740. An ACL is stored in the ACL field 2750.

In the processing of Step S2408, the third row (target row 2784) of the link file management table 2700 is replaced with the fourth row (target row 2786).

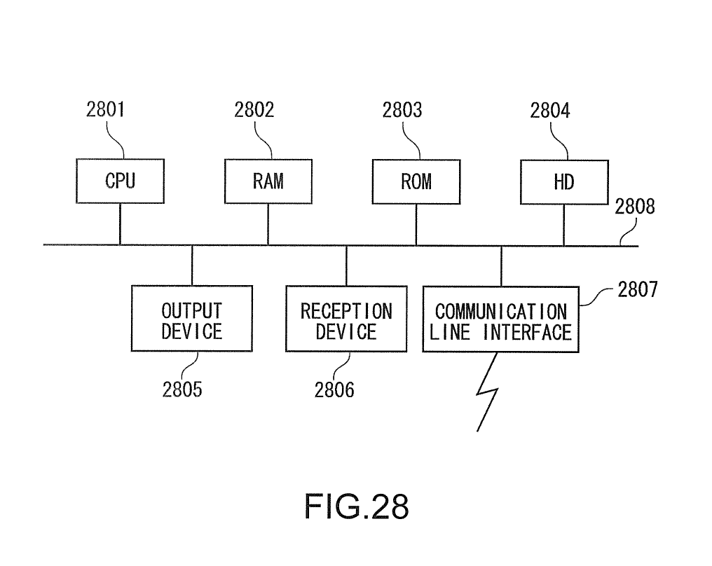

A hardware configuration of a computer, which executes a program, as the present exemplary embodiment is a general computer, specifically, a personal computer or a computer capable of becoming a server, as illustrated in FIG. 28. That is, as a specific example, a CPU 2801 is used as a processing unit (operation unit), a RAM 2802, a ROM 2803, and an HD 2804 are used as a storage device. For example, a hard disk or a solid state drive (SSD) may be used as the HD 2804.

The computer is configured by the CPU 2801 that executes programs such as the communication module 110, the entity file table preparation module 120, the aggregation entity file table preparation module 130, the identical file table preparation module 140, the link and file management table preparation module 150, the relocation crawler 155, the relocation analysis module 160, the cluster division module 165, the relocation module 170, the RAM 2802 in which the program or data is stored, the ROM 2803 in which a program used for starting the computer of the present exemplary embodiment is stored, the HD 2804 which is an auxiliary storage device (which may be a flash memory or the like) having a function of the storage module 180, a reception device 2806 that receives data on the basis of the operation of a keyboard, a mouse, a touch screen, a microphone or the like by a user, an output device 2805 such as a CRT, a liquid crystal device, a speaker or the like, a communication line interface 2807 for connecting with a communication network interface card or the like, and a bus 2808 for connecting the components described above and used for exchanging data between the components. Plural computers each of which is configured by the components may be connected with each other through a network.

Regarding matters corresponding to the computer program of the exemplary embodiments described above, a computer program which is software is read into a system having a hardware configuration of the present exemplary embodiment, and software resources and hardware resources are cooperated with each other to implement the exemplary embodiment described above.

The hardware configuration of the information processing apparatus illustrated in FIG. 28 illustrates just one configuration example, the present exemplary embodiment is not limited to the configuration illustrated in FIG. 28, and may be a configuration in which the modules described in the present exemplary embodiment are adapted to be executable. For example, some of the modules may be configured by exclusive hardware (for example, an application specific integrated circuit (ASIC) or the like), some of the modules may be adapted to be connected by the communication line placed within an external system. Furthermore, plural systems each of which is illustrated in FIG. 28 may be connected to each other by the communication line to be cooperated with each other. In particular, the system may be incorporated into a portable information communication device (including a mobile phone, a smart phone, a mobile device, a wearable computer or the like), home information appliances, a robot, a copy machine, a facsimile, a scanner, a printer, a multifunction machine (image processing apparatus equipped with functions of two or more of a scanner, a printer, a copy machine, a facsimile or the like), in addition to the personal computer.

A file having the number of access times, which is larger than a predetermined number of times or greater than or equal to the predetermined number of times, may be presented from the history of access of the document. Otherwise, a file having the number of access times, which is larger than a predetermined number of times or greater than or equal to the predetermined number of times, within a predetermined period of time may be presented. This is for discovering important knowledge. A destination to be presented may be a user who performs the access and may be other users (for example, such as a manager, a group leader).

A file which exists only in the user terminal 210 obtained by the user and of which update is not performed for a long period of time (which is longer than a predetermined period of time or greater than or equal to the predetermined period of time) may be notified and a command that urges to move the file to the file server 250 may be output (recommended).

In a case where the access count is smaller than the predetermined threshold value or equal to or less than the predetermined threshold value, the entity may be moved to a file server 250 (storage) dedicated for archive. A cost down may be achieved.

In a case where the count of access for the file within the user terminal 210 (corresponds to a local file within the user terminal 210 or the like) from the user terminal 210 is larger than the predetermined threshold value or greater than or equal to the threshold value, the movement of entity may not be performed. Here, the threshold value is set to a value lower than the threshold value used in a case where the movement of entity is performed.

In the compare processing of the description of the exemplary embodiment described above, the expressions “or more”, “or less”, “greater than”, and “less than (smaller than)” may be respectively used as the expressions of “greater than”, “less than (smaller than)”, “or more”, and “or less”, as long as inconsistency in a combination of the expressions does not occur.

The program described above may be provided in a state of being stored in a recording medium or be provided by a communication unit. In this case, for example, the program described above may be considered as an invention of a “computer readable recording medium having a program recorded therein”.

The “computer readable recording medium having a program recorded therein” refers to a recording medium used for installation, execution, distribution or the like of the program, having recorded a program therein, and is readable by a computer.

The recording medium may include, for example, a digital versatile disk (DVD) such as “DVD-R, DVD-RW, DVD-RAM, or the like” that are standards formulated by the DVD forum, “DVD+R, DVD+RW, or the like” that are standards formulated by the DVD+RW, a compact disk (CD) such as a CD-read only memory (CD-ROM), a CD-recordable (CD-R), a CD-rewritable (CD-RW) or the like, a Blu-ray Disc, a magneto-optical disk (MO), a flexible disk (FD), a magnetic tape, a hard disk, a read-only memory (ROM), an electrically erasable programmable read-only memory (EEPROM (registered trademark)), a flash memory, a random access memory (RAM), a secure digital (SD) memory card, or the like.

A portion or the entirety of the program may be recorded in the recording medium to be saved or distributed. The portion or the entirety of the program may be transmitted, by communication, using a transmission medium such as a wired communication network, a wireless communication network, and a combination of the wired communication network and the wireless communication network, that are used, for example, in a local area network (LAN), a metropolitan area network (MAN), a wide area network (WAN), the Internet, the Ethernet, and an extra network, or may be carried by being superposed on a carrier wave.

Furthermore, the program may be a portion or the entirety of another program or may be recorded in the recording medium together with a separate program. The program may be divided to be recorded in plural recording media. The program may be recorded in any format such as a compressed format, an encrypted format, or the like as long as the program is able to be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an extraction unit that extracts an identical document stored in storage places of a plurality of document storage apparatuses;
a determination unit that determines a representative storage place which becomes a representative of the storage places of the plurality of document storage apparatuses; and
a replacement unit that replaces documents which exist in storage places other than the representative storage place with links which point to the representative storage place.

2. The information processing apparatus according to claim 1,
wherein the determination unit determines the representative storage place using a history of access to a document.

3. The information processing apparatus according to claim 2,
wherein the determination unit generates a cluster including a plurality of storage places and determines the representative storage place within the cluster using the history of access in a storage place within the cluster.

4. The information processing apparatus according to claim 1, further comprising:
a assignment unit that assigns an access right management list of the document to each of the links.

5. A non-transitory computer readable medium storing a program causing a computer to function as:
an extraction unit that extracts an identical document stored in storage places of a plurality of document storage apparatuses;
a determination unit that determines a representative storage place which becomes a representative of the storage places of the plurality of document storage apparatuses; and
a replacement unit that replaces documents which exist in storage places other than the representative storage place with links which point to the representative storage place.
